(19) United States
(12) Patent Application Publication
(10) Pub. No.: US 2009/0095813 A1
(43) Pub. Date: Apr. 16, 2009

(54) METHOD AND SYSTEM FOR A KITCHEN INVENTORY BASED ON EXPIRATION OF GOODS

(76) Inventors: BELINDA Y. CHANG, Cary, NC (US); Vijay Dheap, Durham, NC (US); Christopher J. Hardee, Raleigh, NC (US); Heather C. Miller, Holly Springs, NC (US)

Correspondence Address: DILLON & YUDELL LLP, 8911 N. CAPITAL OF TEXAS HWY., SUITE 2110, AUSTIN, TX, 78759, US

(21) Appl. No.: 11/871,788

(22) Filed: Oct. 12, 2007

(51) Int. Cl. G06K 19/00

(52) U.S. Cl. 235/385

(57) ABSTRACT

A method of providing a kitchen inventory based on expiration of goods. A spreadsheet displays a kitchen inventory that includes item names corresponding to multiple currently stored goods. The inventory also includes multiple quantities, expiration dates, remaining time values corresponding to a difference between the expiration dates and a current date, and status values corresponding to the remaining time values. If the currently stored goods change, the spreadsheet updates one or more quantities and expiration dates. If a user requests a recipe, the spreadsheet searches a recipe database for one or more suggested recipes that include one or more of the stored goods having expiration dates in proximity to the current date and outputs one or more suggested recipes. If a user requests a shopping list, the spreadsheet generates a list that includes needed quantities of one or more ingredients in relation to the currently stored goods.

### BACKGROUND OF THE INVENTION

The present invention relates in general to data processing systems and in particular to computer inventory systems.

Kitchens within homes and/or restaurants typically include storage areas for different perishable goods, including, but not limited to, fruits, vegetables, meats, milk, flour, bread, and seasonings. Conventional inventory systems, such as computer spreadsheets, enable a user to track the amounts of various goods that are stored within a kitchen. However, it can be difficult for users of conventional inventory systems to know the condition of goods stored in a kitchen, and perishable items can expire prior to use, thereby creating waste. The replacement of expired perishable goods also increases inventory-related costs.

### SUMMARY OF AN EMBODIMENT

Disclosed are a method, system, and computer storage medium for a kitchen inventory based on expiration of goods. A spreadsheet displays a kitchen inventory that includes item names corresponding to multiple currently stored goods. The inventory also includes multiple quantities, expiration dates, remaining time values corresponding to a difference between the expiration dates and a current date, and status values corresponding to the remaining time values. If the currently stored goods change, the spreadsheet updates one or more quantities and expiration dates based on input from a user, a Radio-Frequency Identification (RFID) reading device, and/or a bar code reading device. If a user requests a recipe, the spreadsheet searches a recipe database for one or more suggested recipes that include one or more of the stored goods having expiration dates in proximity to the current date and outputs one or more suggested recipes. If a user requests a shopping list, the spreadsheet generates a list that includes needed quantities of one or more ingredients in relation to the currently stored goods.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary computer, according to an embodiment of the present invention;

FIG. 2 illustrates an exemplary kitchen inventory, according to an embodiment of the present invention; and

FIG. 3 is a high level logical flowchart of an exemplary method of providing a kitchen inventory based on expiration of goods, according to an embodiment of the invention.

### DETAILED DESCRIPTION OF AN ILLUSTRATIVE EMBODIMENT

The present invention provides a method, system, and computer storage medium for a kitchen inventory based on expiration of goods.

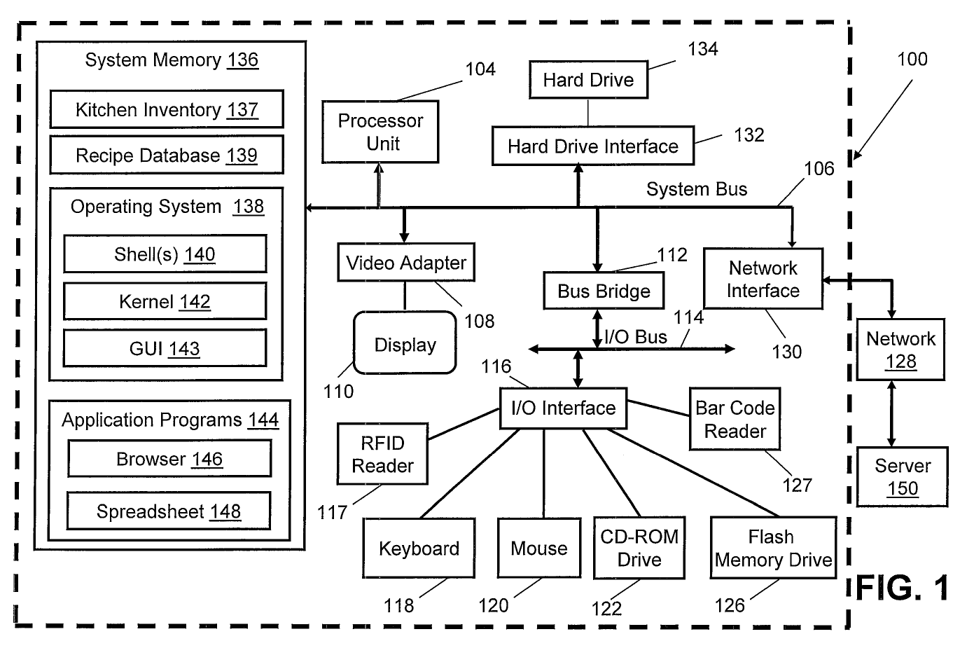

With reference now to FIG. 1, there is depicted a block diagram of an exemplary computer 100, with which the present invention may be utilized. Computer 100 includes processor unit 104 that is coupled to system bus 106. Video adapter 108, which drives/supports display 110, is also coupled to system bus 106. System bus 106 is coupled via bus bridge 112 to Input/Output (I/O) bus 114. I/O interface 116 is coupled to I/O bus 114. I/O interface 116 affords communication with various I/O devices, including keyboard 118, mouse 120, Compact Disk-Read Only Memory (CD-ROM) drive 122, and flash memory drive 126. I/O interface 116 may also be coupled to a Radio-Frequency Identification (RFID) reader 117 and/or a bar code reader 127. The format of the ports connected to I/O interface 116 may be any known to those skilled in the art of computer architecture, including but not limited to Universal Serial Bus (USB) ports.

Computer 100 is able to communicate with server 150 via network 128 using network interface 130, which is coupled to system bus 106. Network 128 may be an external network such as the Internet, or an internal network such as a Local Area Network (LAN), an Ethernet, or a Virtual Private Network (VPN). In one embodiment, server 150 is configured similarly to computer 100.

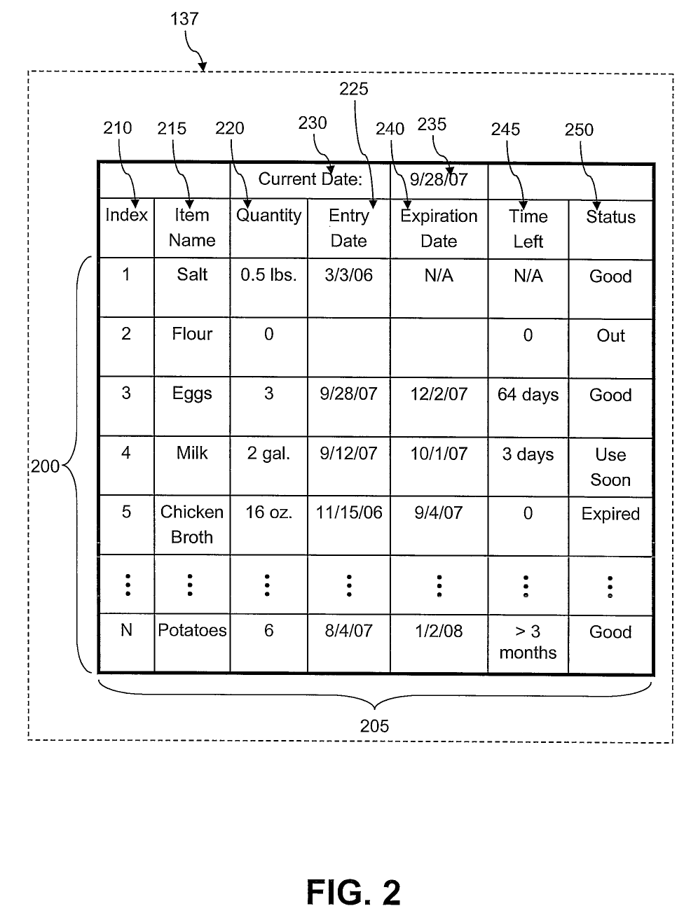

Hard drive interface 132 is also coupled to system bus 106. Hard drive interface 132 interfaces with hard drive 134. In one embodiment, hard drive 134 populates system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Data that populates system memory 136 includes Operating System (OS) 138, application programs 144, kitchen inventory 137, and recipe database 139. Kitchen inventory 137 includes the quantities and expiration dates of multiple goods stored within a pre-defined area. Kitchen inventory 137 may include perishable and/or non-perishable goods. An exemplary kitchen inventory 137 is illustrated in FIG. 2, which is discussed below. Recipe database 139 includes one or more recipes that may use different quantities of goods within kitchen inventory 137 and/or goods that are out of stock (i.e., not currently stored within the area corresponding to kitchen inventory 137). In another embodiment, kitchen inventory 137 and/or recipe database 139 may be stored in server 150 or another storage device, such as flash memory drive 126.

OS 138 includes shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes graphical user interface (GUI) 143 and kernel 142, which includes lower levels of functionality for OS 138. Kernel 142 provides essential services required by other parts of OS 138 and application programs 144. The services provided by kernel 142 include memory management, process and task management, disk management, and I/O device management.

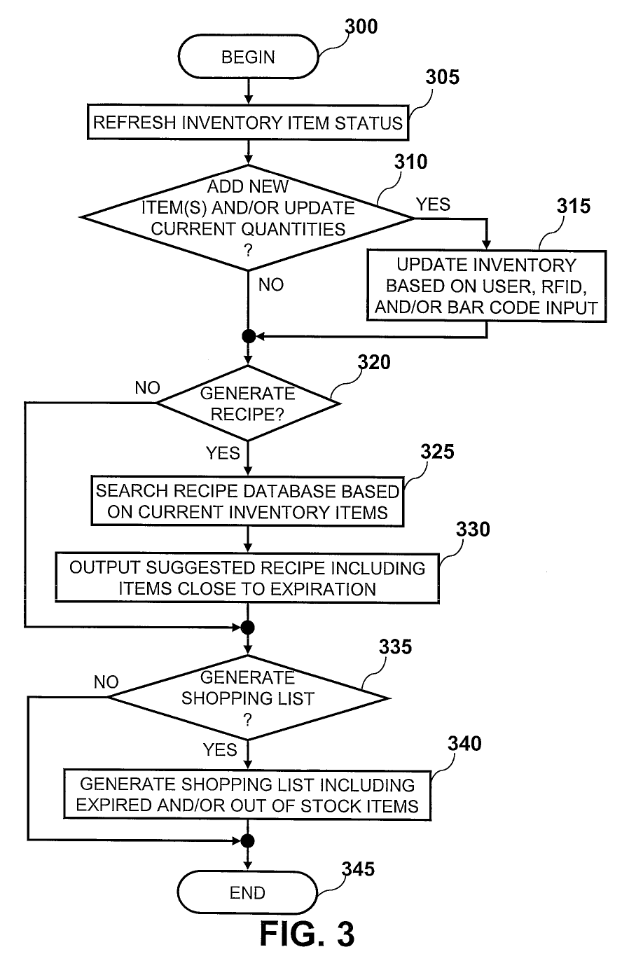

Application programs 144 include browser 146 and spreadsheet 148. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Spreadsheet 148 performs the functions illustrated in FIG. 3, which is discussed below.

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

With reference now to FIG. 2, there is depicted an exemplary kitchen inventory, according to an embodiment of the present invention. As shown, spreadsheet 148 (FIG. 1) displays kitchen inventory 137 using GUI 143 and display 110 (FIG. 1). Kitchen inventory 137 is configured as a table that includes multiple rows 200 and multiple columns 205. In one embodiment, each of rows 200 includes a unique index value 210 (e.g., 1 through N, where N is an integer). Each of rows 200 also includes an item name 215 that corresponds to a good stored within a kitchen. Kitchen inventory 137 also includes a quantity 220, an entry date 225, an expiration date 240, an amount of time left 245 (i.e., a remaining time), and a status 250 for each good. As utilized herein, goods refer to perishable and/or non-perishable items stored within a kitchen, including, but not limited to, fruits, vegetables, meats, milk, flour, bread, and seasonings. In one embodiment, kitchen inventory 137 also includes a current date field 230 and a current date 235. Spreadsheet 148 (FIG. 1) may automatically update current date 235, such that current date 235 corresponds to a date of a clock (not illustrated) within computer 100 (FIG. 1).

According to the illustrative embodiment, a user of spreadsheet 148 may manually input one or more item names 215 into kitchen inventory 137. The user may input quantity 220, which corresponds to an amount of an item currently available. For each good, quantity 220 may include different units based on the type of the item and/or a commonly-acceptable method of measurement for each item. For example, quantity 220 may be a numerical count value (e.g., 6 items), a weight value (e.g., 0.5 pounds), or a volume value (e.g., 2 gallons). The user may also manually input expiration date 240 corresponding to each item. If a good is a non-perishable good, expiration date 240 may be a default value (e.g., “N/A” or a blank value). Spreadsheet 148 may automatically update time left 245 on a periodic basis by subtracting current date 235 from expiration date 240 for each item. Time left 245 may include a specific number of days (e.g., 3 days) that must elapse before a good expires. In one embodiment, time left 245 may include a general time value (e.g., more than 3 months) for one or more goods. If a good does not have an expiration date (e.g., salt), expiration date 240 and/or time left 245 may include a default placeholder value, such as “Not Applicable” (N/A). An exemplary method of updating kitchen inventory 137 is illustrated in FIG. 3, which is described below.

In an alternate embodiment, one or more items may include RFID tags. Each RFID tag may include information corresponding to the name of the item, the quantity of the item, and/or the expiration date of the item. A RFID reading device, such as RFID reader 117 (FIG. 1), may automatically enter the one or more items equipped with RFID tags into kitchen inventory 137 when the one or more items are within range of the RFID reading device. Similarly, in another embodiment, one or more items may include bar codes that include encoded information corresponding to the name, quantity, and/or expiration date of the items. A bar code reading device, such as bar code reader 127 (FIG. 1), may automatically enter the one or more items equipped with bar codes into kitchen inventory 137 when a user moves the items in proximity to the bar code reading device.

According to the illustrative embodiment, spreadsheet 148 automatically updates status 250 for each good based on the value of time left 245 and/or quantity 220. Status 250 may include multiple pre-defined values (e.g., “Good”, “Use Soon”, “Out”, and “Expired”). Spreadsheet 148 may use one or more pre-defined time threshold values to determine when to change the value of status 150. For example, if milk will expire in more than 5 days, spreadsheet 148 may define status 150 of the milk as “Good”. However, once the milk will expire in less than 5 days, spreadsheet 148 may update status 150 to “Use Soon”. Similarly, spreadsheet 148 may change the value of status 150 if quantity 220 is above a pre-defined quantity threshold value when time left 245 approaches the pre-defined time threshold value (e.g., if 10 gallons of milk are left that will expire in 7 days). Kitchen inventory 137 may thus help prevent a user from consuming items too slowly. If quantity 220 is equal to 0, or if quantity 220 is below a user-defined threshold value, spreadsheet 148 may display time left 245 as “0” and/or display status 250 as “Out”. An exemplary method of updating kitchen inventory 137 is illustrated in FIG. 3, which is described below.

Turning now to FIG. 3, there is illustrated a high level logical flowchart of an exemplary method of providing a kitchen inventory based on expiration of goods, according to an embodiment of the invention. The process begins at block 300 in response to a user of computer 100 (FIG. 1) accessing and/or viewing kitchen inventory 137 (FIGS. 1-2). Spreadsheet 148 (FIG. 1) refreshes kitchen inventory 137 by updating current date 235, time left 245, and status 250 (FIG. 2), as depicted in block 305.

At block 310, spreadsheet 148 determines whether or not a user wishes to add one or more new goods and/or update one or more quantities 220 of currently stored goods. In one embodiment, spreadsheet 148 may use GUI 143 and one or more input devices coupled to I/O interface 116 (e.g., keyboard 118 and/or mouse 120 of FIG. 1) to receive user input data. In another embodiment, spreadsheet 148 may automatically receive input data corresponding to one or more new goods and/or updated quantities 220 from RFID reader 117 (FIG. 1) and/or a bar code reader 127 (FIG. 1). If no new goods and/or current quantities 220 are updated, the process proceeds to block 320. Otherwise, if a user wishes to add one or more new goods and/or update one or more quantities 220, spreadsheet 148 updates kitchen inventory 137 based on user input, as shown in block 315.

At block 320, spreadsheet 148 determines whether or not a user wishes to generate one or more recipes from recipe database 139 (FIG. 1) that include goods from kitchen inventory 137. If a user does not wish to generate a recipe, the process proceeds to block 335. Otherwise, if a user wishes to generate a recipe, spreadsheet 148 searches recipe database 139 to find one or more recipes that include goods within kitchen inventory 137, as depicted in block 325. Spreadsheet 148 outputs one or more recipes that include ingredients having expiration dates in proximity to current date 235 and/or values of status 250 corresponding to “Use Soon”, as shown in block 330. Spreadsheet 148 thus uses kitchen inventory 137 to enable a user to efficiently consume goods that are closest to expiration, thereby reducing waste and saving money. In an alternate embodiment, spreadsheet 148 may prioritize and output recipes based on a user-defined threshold level corresponding to the proximity to current date 235 and/or the definition of a “Use Soon” value of status 250.

At block 335, spreadsheet 148 determines whether or not a user wishes to generate a shopping list that includes goods that are currently out of stock (i.e., goods with an “Out” value of status 250) and/or goods included in a suggested recipe that currently have a value of quantity 220 that is less than the required quantity for the suggested recipe. If a user does not wish to generate a shopping list, the process terminates at block 345. If a user wishes to generate a shopping list, spreadsheet 148 generates a shopping list that includes one or more goods that are currently expired, out of stock, and/or goods having quantities that are insufficient to complete a suggested recipe, as depicted in block 340. The process subsequently terminates at block 345.

The present invention thus provides a method of updating a kitchen inventory based on expiration of goods. Spreadsheet 148 (FIG. 1) displays kitchen inventory 137 (FIGS. 1-2) that includes item names 215 (FIG. 2) corresponding to multiple currently stored goods. Kitchen inventory 137 also includes multiple quantities 220, expiration dates 240, remaining time values (i.e., time left 245) corresponding to a difference between expiration dates 240 and current date 235, and status values 250 corresponding to the remaining time values. If the currently stored goods change, spreadsheet 148 updates one or more quantities 220 and expiration dates 240 based on input from a user, RFID reader 117 (FIG. 1), and/or bar code reader 127 (FIG. 1). If a user requests a recipe, spreadsheet 148 searches recipe database 139 (FIG. 1) for one or more suggested recipes that include one or more of the stored goods having expiration dates 240 in proximity to current date 235 and outputs one or more suggested recipes. If a user requests a shopping list, spreadsheet 148 generates a list that includes needed quantities of one or more ingredients in relation to the currently stored goods.

It is understood that the use herein of specific names are for example only and not meant to imply any limitations on the invention. The invention may thus be implemented with different nomenclature/terminology and associated functionality utilized to describe the above devices/utility, etc., without limitation.

In the flow chart (FIG. 3) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of the types of media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method comprising:
displaying a kitchen inventory that includes:
a plurality of item names that correspond to a plurality of currently stored goods;
a plurality of quantities that correspond to said plurality of item names;
a plurality of expiration dates that correspond to said plurality of currently stored goods;
a plurality of remaining time values that each correspond to a difference between one of said plurality of expiration dates and a current date; and
a plurality of status values that correspond to said plurality of remaining time values;
in response to a change in said plurality of currently stored goods, updating one or more of said plurality of quantities and said plurality of expiration dates;
in response to a request for a recipe:
searching a recipe database that includes a plurality of recipes for one or more suggested recipes that include one or more of said plurality of stored goods having expiration dates in proximity to said current date; and
outputting said one or more suggested recipes; and
in response to a request for a shopping list, generating said shopping list that includes needed quantities of one or more ingredients of said one or more suggested recipes in relation to said plurality of currently stored goods.

2. The method of claim 1, wherein updating said plurality of quantities further comprises automatically adjusting a value of one or more of said quantities in response to an input from a Radio-Frequency Identification (RFID) device.

3. The method of claim 1, wherein updating said plurality of quantities further comprises automatically adjusting a value of one or more of said quantities in response to an input from a bar code device.

4. A computer system comprising:
a processor;
a network interface coupled to said processor, wherein said network interface enables said computer system to communicate with a server via a network;
a system memory coupled to said processor;
a kitchen inventory within said system memory; and
a spreadsheet application program within said system memory that provides the functions of:
displaying a kitchen inventory that includes:
a plurality of item names that correspond to a plurality of currently stored goods;
a plurality of quantities that correspond to said plurality of item names;
a plurality of expiration dates that correspond to said plurality of currently stored goods;
a plurality of remaining time values that each correspond to a difference between one of said plurality of expiration dates and a current date; and
a plurality of status values that correspond to said plurality of remaining time values;
in response to a change in said plurality of currently stored goods, updating one or more of said plurality of quantities and said plurality of expiration dates;
in response to a request for a recipe:
searching a recipe database that includes a plurality of recipes for one or more suggested recipes that include one or more of said plurality of stored goods having expiration dates in proximity to said current date; and
outputting said one or more suggested recipes; and
in response to a request for a shopping list, generating said shopping list that includes needed quantities of one or more ingredients of said one or more suggested recipes in relation to said plurality of currently stored goods.

5. The computer system of claim 4, wherein updating said plurality of quantities further comprises means for automatically adjusting a value of one or more of said quantities in response to an input from a Radio-Frequency Identification (RFID) device.

6. The computer system of claim 4, wherein updating said plurality of quantities further comprises means for automatically adjusting a value of one or more of said quantities in response to an input from a bar code device.

7. A computer storage medium encoded with a computer program that, when executed, performs the steps of:
displaying a kitchen inventory that includes:
a plurality of item names that correspond to a plurality of currently stored goods;
a plurality of quantities that correspond to said plurality of item names;
a plurality of expiration dates that correspond to said plurality of currently stored goods;
a plurality of remaining time values that each correspond to a difference between one of said plurality of expiration dates and a current date; and
a plurality of status values that correspond to said plurality of remaining time values;
in response to a change in said plurality of currently stored goods, updating one or more of said plurality of quantities and said plurality of expiration dates;
in response to a request for a recipe:
searching a recipe database that includes a plurality of recipes for one or more suggested recipes that include one or more of said plurality of stored goods having expiration dates in proximity to said current date; and
outputting said one or more suggested recipes; and
in response to a request for a shopping list, generating said shopping list that includes needed quantities of one or more ingredients of said one or more suggested recipes in relation to said plurality of currently stored goods.
